(19) United States
(12) Patent Application Publication
(10) Pub. No.: US 2013/0217454 A1
(43) Pub. Date: Aug. 22, 2013

(54) EDUCATIONAL MATCHING CARD GAME

(71) Applicants: Joseph F. LaFrance, Holley, NY (US); Diane M. LaFrance, Holley, NY (US)

(72) Inventors: Joseph F. LaFrance, Holley, NY (US); Diane M. LaFrance, Holley, NY (US)

(21) Appl. No.: 13/767,284

(22) Filed: Feb. 14, 2013

Related U.S. Application Data
(60) Provisional application No. 61/599,691, filed on Feb. 16, 2012.

(51) Int. Cl. A63F 1/02; A63F 1/06; A63F 13/02; A63F 13/00

(52) U.S. Cl. CPC A63F 1/02; A63F 13/005; A63F 1/06; A63F 13/02
USPC 463/11; 273/294; 283/67; 463/47

(57) ABSTRACT

A method for playing an educational card game is provided. The method comprises (a) providing a plurality of cards placed in a deck, wherein each of the plurality of cards comprises at least two unique elements and each of the plurality of cards comprises one element common with other cards of the plurality of cards and randomly assigning a card of the plurality of cards to each of the at least two players; (b) selecting a seed card from the deck by each of the at least two players; (c) placing a card from the plurality of cards between the at least two players; (d) identifying, calling the common element between the card and the seed card and collecting the card by a player of the at least two players, wherein the card is now treated as the seed card; and (e) repeating steps (c)-(d) until the deck is depleted.

### PRIORITY CLAIM AND RELATED APPLICATIONS

This non-provisional application claims priority to provisional application U.S. Ser. No. 61/599,691 filed Feb. 16, 2012. Said application is incorporated by reference herein in its entirety.

### BACKGROUND OF THE INVENTION

1. The Field of the Invention

The present invention is directed generally to educational games. More specifically, the present invention is directed to an educational matching card game for teaching children cognitive and language skills.

2. Background Art

A variety of educational games and teaching aids have been used to teach children cognitive and language skills. Conventional approaches include flash cards, matching cards, electronics-embedded books, and paper or electronic instruction books (which typically involve individual matching/writing/drawing activities). Flash cards are simple to construct and use, however, they lack the element of competition, an inspiring and exciting element that makes learning fun for children. Flash cards are a proven effective learning tool, however, in the current electronic age, they do not capture the attention and interest of children as easily as other activities. Typical flash cards are read aloud while they are being held up. Even electronic versions of games on electronic touch pads or computer screens lack the excitement factor that children demand and have come to expect in their daily activities.

U.S. Pat. Pub. No. 20110031693 discloses a matching-based competitive game that is used to reinforce the association, correlation, translation, or equation of values. The values are indicia on the face of the tiles, where each tile has at least two different indicia. These values may be cross-language vocabulary words, geographic entities, arithmetic valuations, or chemical symbols, as examples. The classic game of dominoes provides a single tile for every combination of two values in the value set, including the identity element. The winner(s) of the game are defined as the first player(s) who complete a predetermined number of matches of the indicia values on their tiles. This game lacks the number of indicia which players would need to browse through to arrive at the right match, thereby limiting the exposure of players to a wide variety of indicia and hence the educational value of the game.

U.S. Pat. Pub. No. 20070205556 discloses a method for displaying a plurality of indicia-bearing game pieces on a gaming grid. A player selects game pieces that are adjacent and that have matching indicia. One or more prizes are awarded in association with the selection and removal of the matching adjacent game pieces. Preferably, the player is also provided with the ability to shuffle any remaining non-selected game pieces, after all matching adjacent game pieces that are perceived by the player are selected and removed. This game also lacks the number of types of indicia which players would need to browse through to arrive at the right match, thereby limiting the exposure of players to a wide variety of indicia and hence the educational value of the game.

U.S. Pat. No. 8,070,164 discloses a child's memory game which utilizes a plurality of miniature chairs and smaller play pieces. The play pieces all depict characters related to a particular subject, e.g. breakfast food. The chairs are lined up with their backs facing the players. One character play piece is placed on each chair, out of sight of the players. The players alternate guessing the location of play pieces and are awarded the chairs and play pieces when they guess correctly. The player with the most chairs and play pieces is the winner. This game lacks an element which encourages competition and may not be practical to be adapted for computer use as it requires play pieces which are not flat or in the form of cards.

A card game called Spot It! produced by Blue Orange™ offers a deck of round cards having images of varying sizes randomly disposed on each card. There exists a common image between any two cards. During play, each player is assigned the same number of cards and a seed card is disposed between the players. The object of the game is to identify the common element of a player's card and the seed card disposed between the players and remove of the player's card from the player's private deck and dispose of it upon the seed card. The disposed card now becomes the seed card for the next round of play for all players. The game is limited to images and lacks the variety of elements, such as words which may interest children, especially those who are still in the early stage of learning a language. The fact that the images are randomly distributed and sized on each card may prove to be a detriment as some children may find the game to be too challenging if the main goal of the game is to be realized. Instead of focusing on the learning the elements introduced on each card, the players may simply recognize the shapes of the elements.

Thus, there arises a need for an educational game that is engaging, fun, simple to play, simple in construction and economical that incorporates an element of competition.

### SUMMARY OF THE INVENTION

The present invention is directed toward a method and apparatus for playing an educational card game. The method comprises:
(a) providing a plurality of cards placed in a deck, wherein each of the plurality of cards comprises at least two unique indicia or elements and each of the plurality of cards comprises one element common with any one of the other cards of the plurality of cards and randomly assigning a card of the plurality of cards to each of at least two players;
(b) selecting a seed card from the deck by each of the at least two players;
(c) placing a card from the plurality of cards between the at least two players;
(d) identifying, calling the common element between the card and the seed card and collecting the card by a player of the at least two players who identified and called the common element, wherein the card is now treated as the seed card; and (e) repeating steps (c)-(d) until the deck is depleted.

There is further provided a method of providing a plurality of cards having one common element between any two cards. Each of the plurality of cards comprises a quantity of elements and each of the plurality of cards has one element in common with any one of the other cards of the plurality of cards. The plurality of cards comprises a list of unique elements having a size, a head element corresponding to the first member of the list.

The method comprises:
(a) providing a table having a plurality of matrices, wherein each matrix is composed of a plurality of rows and a plurality of columns, the table comprises a total number of matrices equal to the quantity of elements, a first matrix of the table is a square matrix having a size of the quantity of elements by the quantity of elements, other matrices of the table include a size of (the quantity of elements of rows−1) by the quantity of elements;
(b) populating the leftmost column of each matrix with a member of the list starting from the head element such that the leftmost column of each matrix is populated with a member of the list common within each matrix, leaving behind an empty section in each matrix;
(c) populating the empty section of the first matrix by filling the first matrix, in the order of members of the list, in a row-by-row, left-to-right and top-to-bottom fashion, starting with a second member of the list until the empty section of the first matrix is completely filled;
(d) populating the empty section of a second matrix by filling the second matrix, in the order of members of the list, in a column-by-column, left-to-right and top-to-bottom fashion, starting with the member of the list that is used to fill the second row, second column position of the first matrix until the empty section of the second matrix is completely filled;
(e) assigning previously filled matrix as a current matrix;
(f) duplicating the filled empty section of the current matrix adjacent the right side of the current matrix to form a ghost section; and
(g) populating the empty section of a next matrix by transposing left-to-right, top-to-bottom diagonal members of the combined filled empty section of the current matrix and the ghost section of the current matrix, in a row-by-row, left-to-right and top-to-bottom fashion,

wherein steps (e)-(g) are repeated until all empty sections of all matrices have been filled and members of each filled row of all of the matrices constitute combinations of a card.

In accordance with the present invention, there is provided a card game having a plurality of cards. The plurality of cards comprises at least two unique elements. Each of the plurality of cards comprises one element common with any one of the other cards of the plurality of cards. Each of the at least two unique elements is selected from the group consisting of words, numbers, images, symbols, mathematically equivalent statements, words of different languages and patterns or any combinations thereof. Each of the plurality of cards comprises a circular shape and the at least two unique elements are disposed adjacent an outer periphery of each of the plurality of cards.

Accordingly, it is a primary object of the present invention to provide an educational card game that combines elements of fun, competition, ease of play and ease in construction in one package.

It is another object of the present invention to provide a method for yielding combinations of elements for game cards.

It is yet a further object of the present invention to be adaptable for use on a computer.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a plan view of several card game cards according to the present invention.

FIG. 2 is a perspective view of decks of card game cards according to the present invention.

FIG. 2A is a plan view of a present card game card having eight elements.

FIG. 2B is a plan view of another example of a present card game card having eight elements radially aligned about the center of the card.

FIG. 2C is a plan view of a present card game card having eight words aligned inwardly about the center of the card.

FIG. 2D is a plan view of a present card game card having eight symbols disposed about the center of the card.

FIG. 2E is a plan view of a pair of present card game cards having eight words aligned outwardly about the center of the card where a word in one language on one card is matched with a word in another language on another card.

FIG. 2F is a plan view of a pair of present card game cards having eight numbers aligned outwardly about the center of the card where an arithmetic operation on one card is matched with a number on another card.

FIG. 3 depicts an example of combinations of words which make up each card game card.

FIG. 4 depicts an example of common elements shared between cards.

FIG. 5 depicts a table showing combinations of elements which make up each card game card.

FIG. 6 depicts another table showing combinations of elements which make up each card game card.

FIG. 7 depicts several matrices with the leftmost columns filled.

FIG. 8 depicts the first matrix filled with unique elements.

FIG. 9 depicts the second matrix filled with unique elements.

FIG. 10 depicts a method by which the third matrix is filled.

FIG. 11 depicts the third matrix filled with unique elements.

FIG. 12 depicts all matrices including filled ghost sections.

FIG. 13 depicts the present invention adapted for use on a computer.

### PARTS LIST

2—card

4—element

6—angle between two elements

8—deck of cards

10—matrix

12—leftmost column

14—all columns of matrix except the leftmost column

16—electronic touch pad

18—second row of first matrix less the leftmost column

20—second column of second matrix

22—direction in which the empty section of the first matrix is populated

24—direction in which the empty section of the second matrix is populated

26—diagonally disposed elements

28—ghost section

30—touchscreen

32—deck of cards represented on a touchscreen

34—soft button for selecting new card

36—score

38—button to acknowledge a player has identified the common element between the player's card and the top card of the deck.

### PARTICULAR ADVANTAGES OF THE INVENTION

The present card game is educational, fun, challenging and exciting to play. It is an effective learning tool as it improves visual discrimination, improves visual associations, increases brain connections for visual memory, recall, and retrieval of information, provides important practice of skills for learning with automaticity, provides educational opportunity in a new and exciting way, maintains a child's interest by being entertaining, competitive, challenging and fun. It is also easy to use, simple to manufacture and economical, can be played in small groups or independently, can also be a computer/electronic/pad game. The present game is conducive to several different versions of the game that will target different skills including higher level skills as well as second language learners. In some embodiments of the present card game, the number of unique elements used is significantly higher than the prior art. For example, for an eight-element per card configuration, there are fifty seven unique elements possible. The users are therefore visually exposed to a vast variety of elements, thereby enhancing the educational value of the present card game.

### DETAILED DESCRIPTION OF A PREFERRED EMBODIMENT

FIG. 1 is a plan view of several card game cards 2 according to the present invention. Central to this card game is a method by which a deck of cards is designed which will be disclosed elsewhere in this disclosure. FIG. 1 represents several cards out of a deck of many more cards. Each card has a front face and a rear face and is essentially configured in a circular shape. Each card comprises at least two unique elements.

In the embodiment shown in FIG. 1, each card is configured to have six unique elements 4 on the front face of the card. Each element is shown as a generic rectangular box to represent its relative positioning with respect to the periphery of each card and other elements. Elements 4 of a card 2 are symmetrically and angularly disposed about the center of the card 2 and two elements 4 are separated by an angle 6. Each element is preferably disposed adjacent the outer periphery of a card 2. In one embodiment, an element can be a word, number, symbol, pattern, mathematical statement, an image or any combinations thereof.

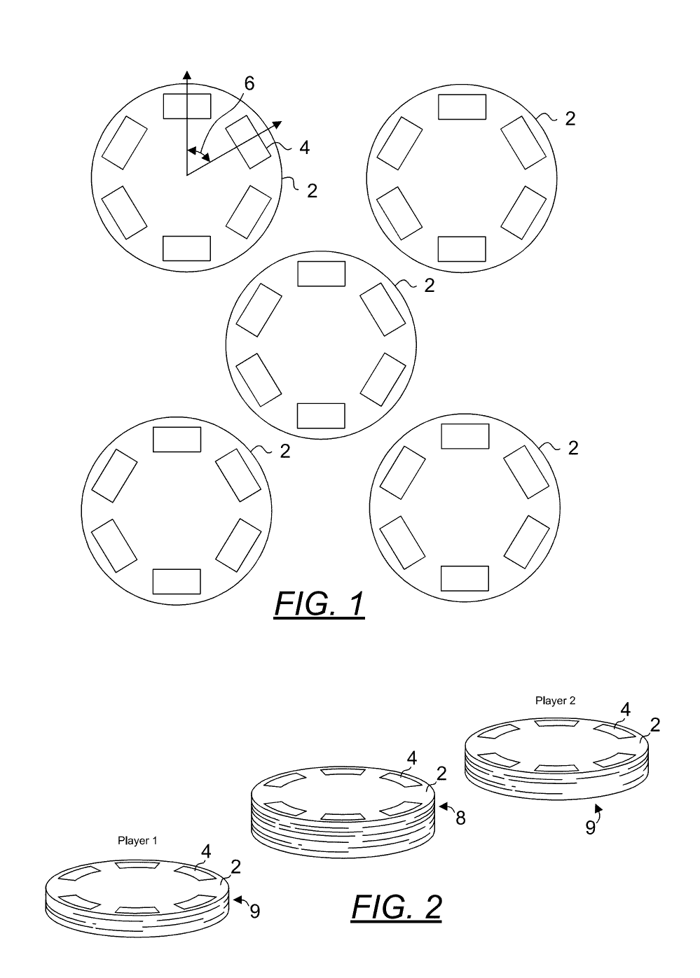

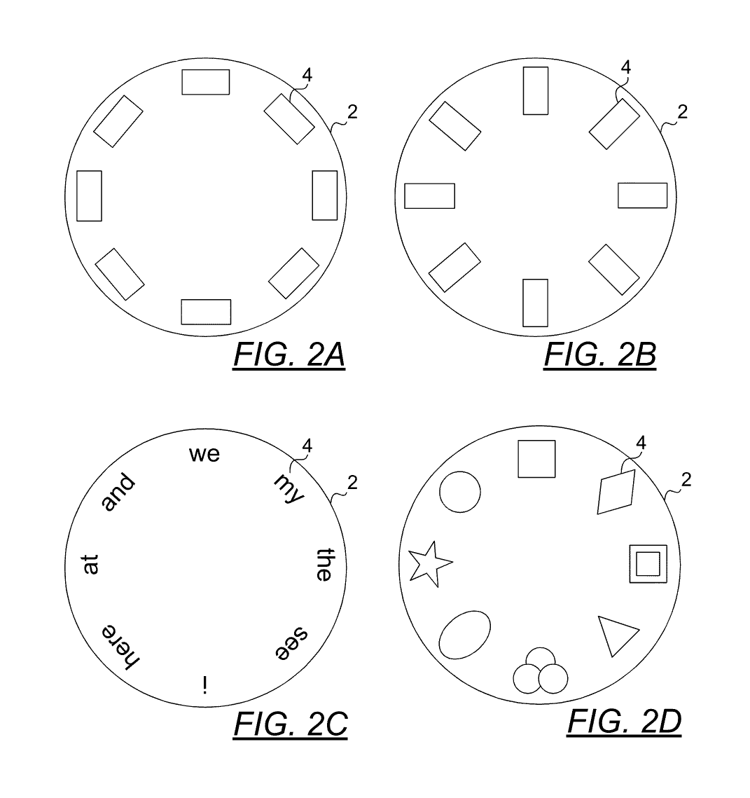

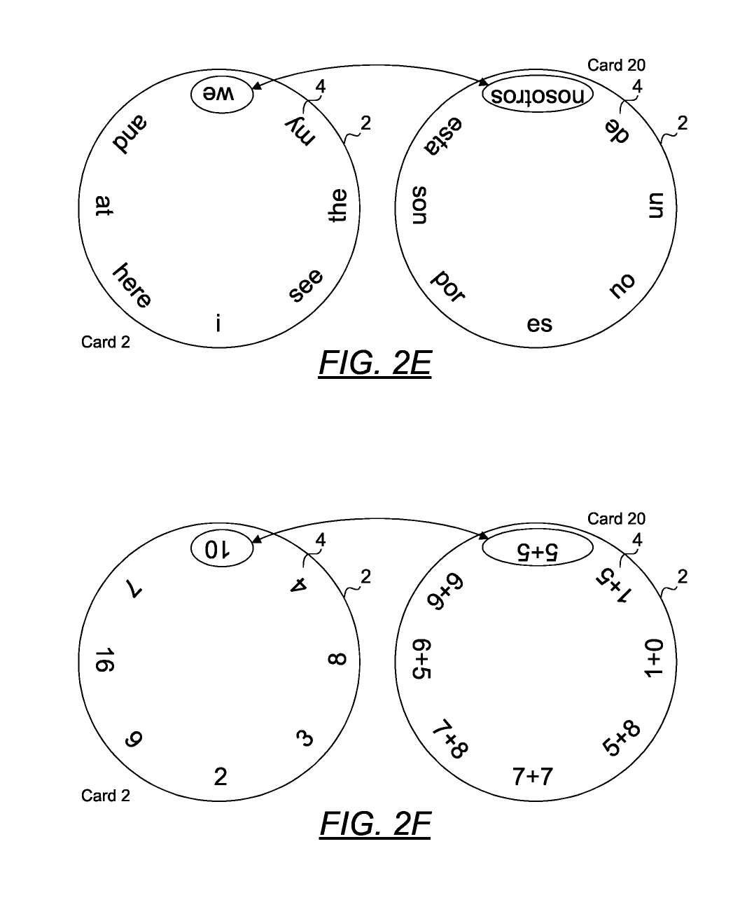

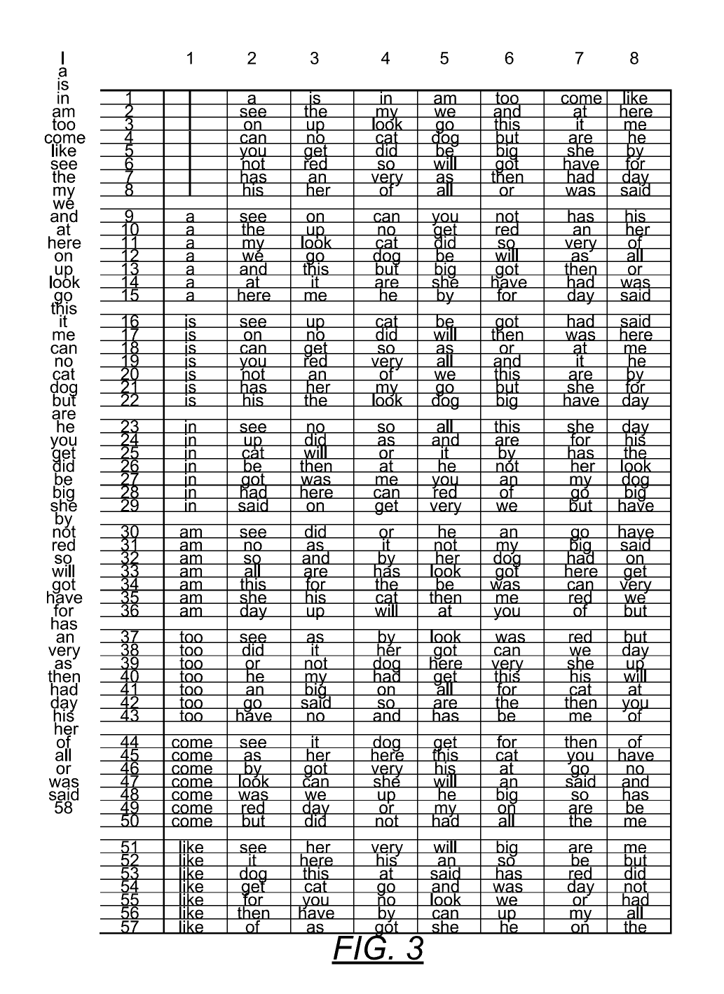

In playing the present card game, a plurality of cards is provided and placed in a deck as shown in FIG. 2. FIG. 2 is a perspective view of decks of card game cards according to the present invention. The central deck 8 represents the deck of cards from which a card is drawn. The central deck 8 is shown with the front face facing upwardly. The central deck may alternatively be placed with the elements facing downwardly to increase the element of surprise when a card is drawn to reveal the elements disposed thereon. The two outer decks 9 represent the private decks of cards collected by players 1 and 2 from the central stack. The object of the game is for a player to collect as many cards as possible. The player who first identifies and calls the common element between his (or seed) card and the card drawn from the deck is awarded the card drawn from the deck. For the subsequent round of play, the card that has just been collected now becomes the seed card to be matched with the next card drawn from the deck. In every round of play, one card is drawn from the deck for the benefit of every player. Therefore, despite having an individual or private deck of collected cards, each player is forced to interact with other players in each round of play, thereby engendering an element of competition and excitement among every player. The winner of the game is one who collects the highest number of cards when the deck is depleted.

The Applicants discovered that children of young ages especially benefit from this card game as the children can learn to visually discriminate dissimilar words and improve visual associations. The use of present card game also enhances visual memory, recall, retrieval of information, automaticity and the subject matter of the cards themselves. Users of the present card game learn to associate a single unique word from two different pools (due to two different cards) of words, thereby requiring the users to pick out one element from a first card at one time and attempt to match the element to an element on a second card. This process is repeated for all other elements of the first card.

In selecting the subject matter for a present deck of cards, the Applicants discovered the benefit of selecting the elements categorically. For instance, a deck of cards may display a vast variety of flying birds, extinct dinosaurs or ocean creatures. In picking out the correct answer while playing the game, each player would have “browsed” through at least some of the elements of the seed card and the card at the top of the deck. In doing so, the players would have been exposed to a vast variety of words, vocabulary or images. Such activity enhances visual association of the subject matter with words or images displayed on the cards.

FIG. 2A is a plan view of a present card game card having eight unique elements. The Applicants determined that a card having eight unique elements present suitable level of challenge for players of any ages, especially among children in their early formative years. FIG. 2B depicts another embodiment of the present card game card comprising eight elements that are radially aligned about the center of the card. FIG. 2C is a plan view of a present card game card having eight words aligned inwardly disposed about the center of the card. As will be disclosed elsewhere in this disclosure, the words may be aligned outwardly to achieve significantly the same result. FIG. 2D is a plan view of a present card game card having eight symbols disposed about the center of the card.

FIG. 2E is a plan view of a pair of present card game cards having eight words aligned outwardly about the center of the card where a word in one language on one card is matched with a word in another language on another card. For instance, the English word “we” on the left card (Card 2) is matched with the Spanish word “nosotros” on the right card (Card 20). In one embodiment not shown, each card may also include a mixture of more than one language. FIG. 2F is a plan view of a pair of present card game cards having eight numbers aligned outwardly about the center of the card where an arithmetic operation on one card is matched with a number on another card. For instance, the arithmetic operation of “5+5” on the right card (Card 20) is equivalent to the result of “10” on the left card (Card 2). In another embodiment not shown, a number on one card is configured to be matched to a group of dots on another card where the number of dots represents the number.

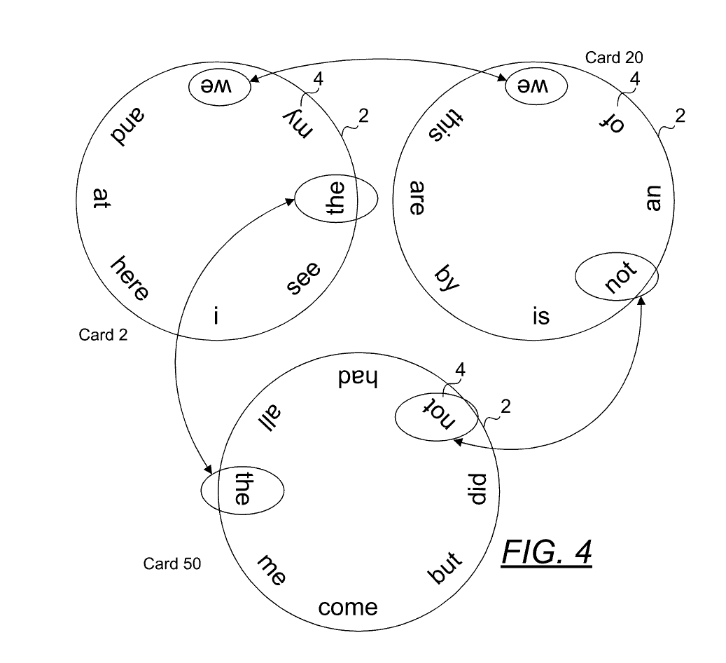

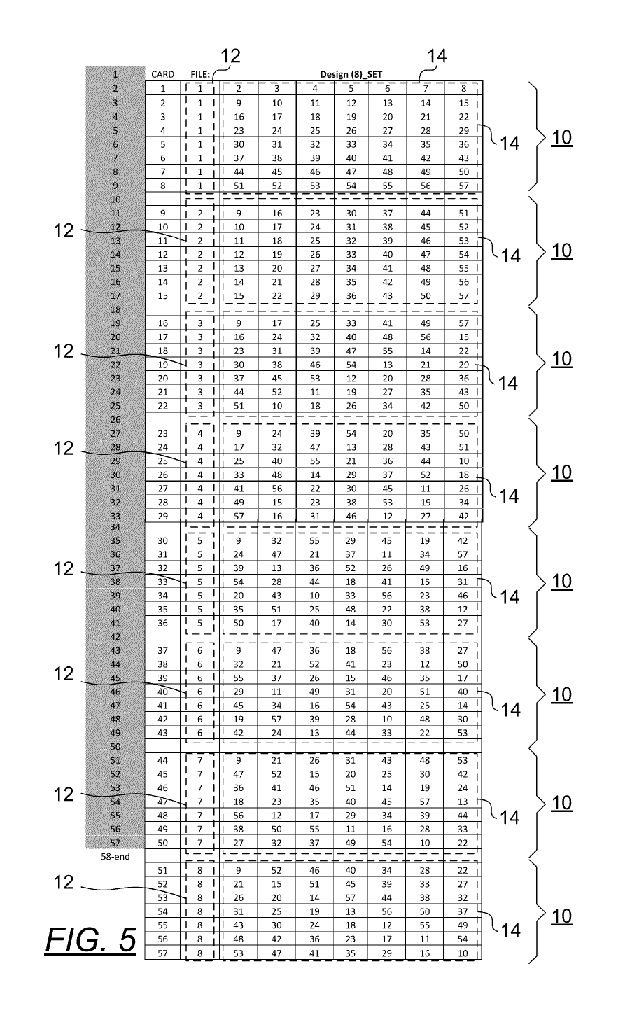

FIG. 3 depicts an example of combinations of words which make up each card game card. In this case, there are fifty seven unique elements. Each line of the table represents elements which make up a card. FIG. 4 depicts an example of common elements shared between cards. Each of the plurality of cards comprises one element common with other cards of the plurality of cards. Card 2, 20 and 50 consist of the following elements respectively:

Card 2: “I” “see” “the” “my” “we” “and” “at” “here”

Card 20: “is” “not” “an” “of” “we” “this” “are” “by”

Card 50: “come” “but” “did” “not” “had” “all” “the” “me”

Card 2 shares the word “we” with card 20. Card 20 shares the word “not” with card 50. Card 2 shares the word “the” with card 50. The present card game involves at least two players, however, four players is an ideal number as a player has to remain in close proximity to the cards in order to retain visual contact with the elements of the card.

In play, each player is randomly assigned a card from the deck. Ideally, the deck of FIG. 2 should be placed with the front face down to conceal the elements before a card is drawn from the deck. To begin playing, a card is drawn from the deck as a seed card for each player. In each turn or round of play, a card is drawn by one of any players from the top of the deck and placed between the players. The player who identifies and calls the common element between the card placed between the players and the seed card gets to collect the card. This process is repeated by drawing another card from the top of the deck until the deck is depleted. It shall also be noted that, contrary to the elements of FIG. 2C, the elements of FIG. 4 are disposed in an inwardly fashion with respect to the periphery of the circularly shaped cards.

FIG. 5 depicts a table showing combinations of elements which make up each card game card. Although this disclosure depicts a method to yield unique 8-element combinations of fifty seven elements, this technique is applicable to other combinations as well, such as 4-element, etc. For an 8-element deck, there are (8×(8−1))+1 or 57 combinations or (K×(K−1))+1, where K represents the number of elements on any one card. The number of matrices equals K. For a 4-element deck, there are (4×(4−1))+1 or 13 combinations. The table is composed of a plurality of matrices. For a 6-element deck, there are (6×(6−1))+1 or 31 combinations. Each matrix comprises a leftmost column 12 and other columns 14. The number of rows of the first matrix and other matrices are K and K-1, respectively.

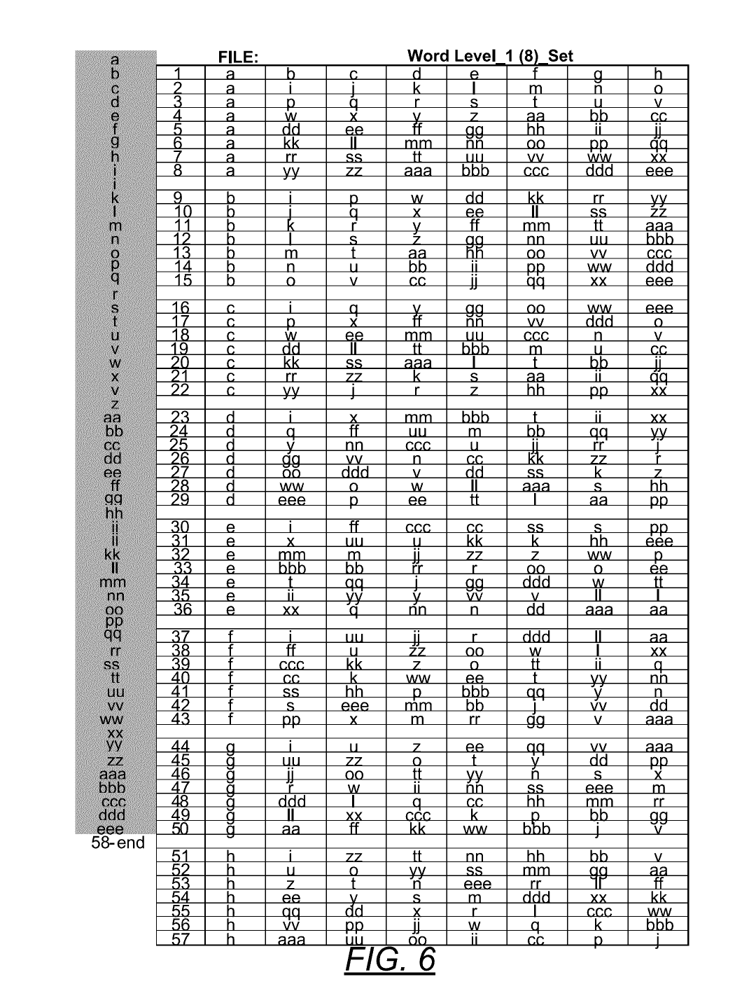

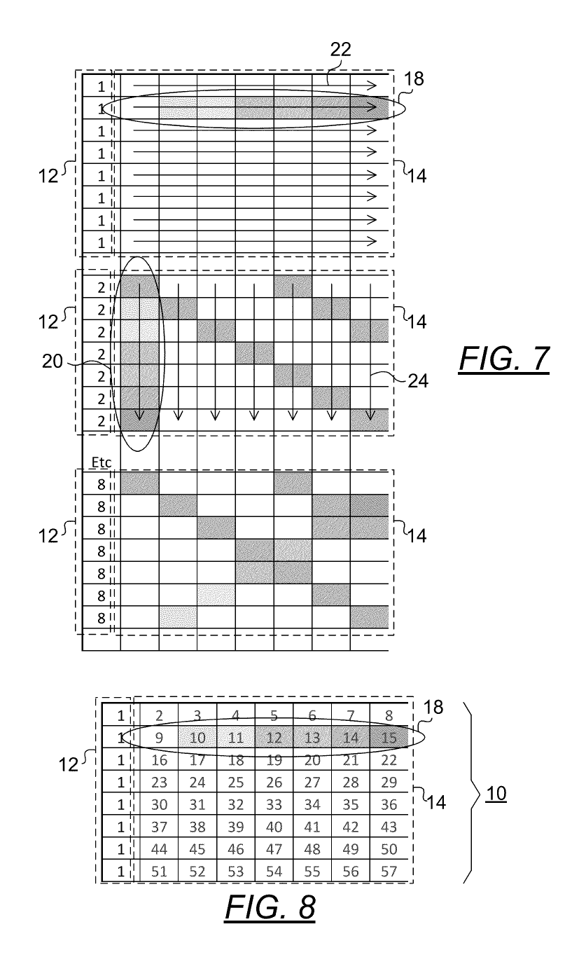

FIG. 6 depicts another table showing combinations of elements which make up each card game card. This table is essentially identical to FIG. 5, except each element is represented with a letter or a combination of letters. This table helps in demonstrating that the elements of a card is interchangeable with any numbers, words, images, symbols, mathematically equivalent statements, words of two different languages and any combinations of these elements thereof. FIG. 7 depicts a portion of the matrices of FIG. 5 with the leftmost columns filled and the elements of other columns removed to demonstrate the steps taken to populate the matrices 10. FIG. 8 depicts the first matrix 10 already filled with unique elements.

In yielding a plurality of cards, each comprising a quantity of elements and each has one element in common with another card of the plurality of cards, the Applicants have devised a novel method to populate the matrices of FIG. 5. The plurality of cards comprises a list of unique elements having a size and a head element corresponding to the first member of the list. The size in this example is fifty seven as there are fifty seven unique elements in the list. The first member of the list according to FIG. 5 is “1.”

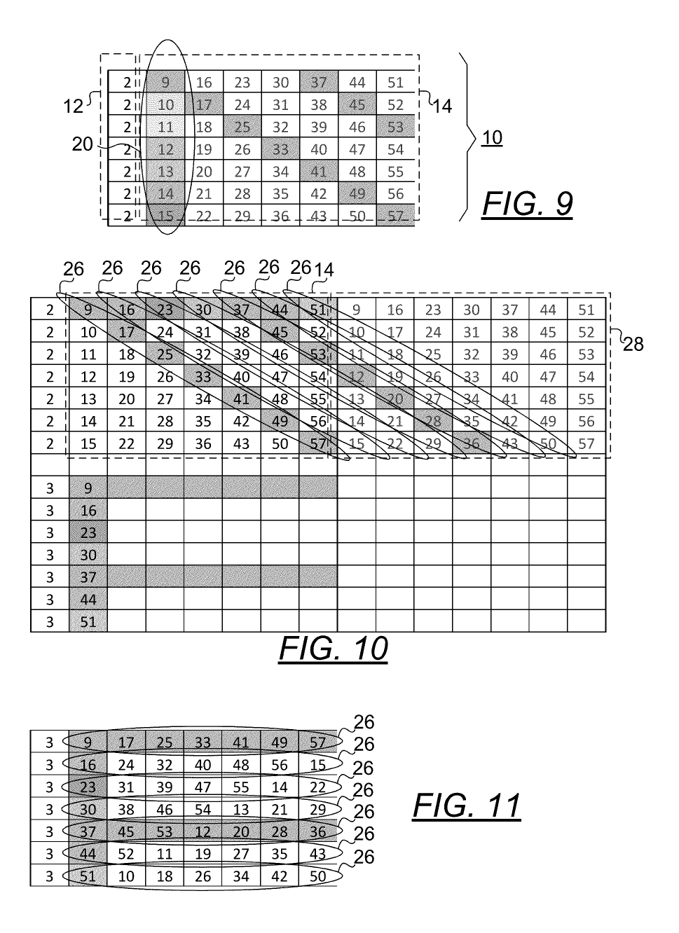

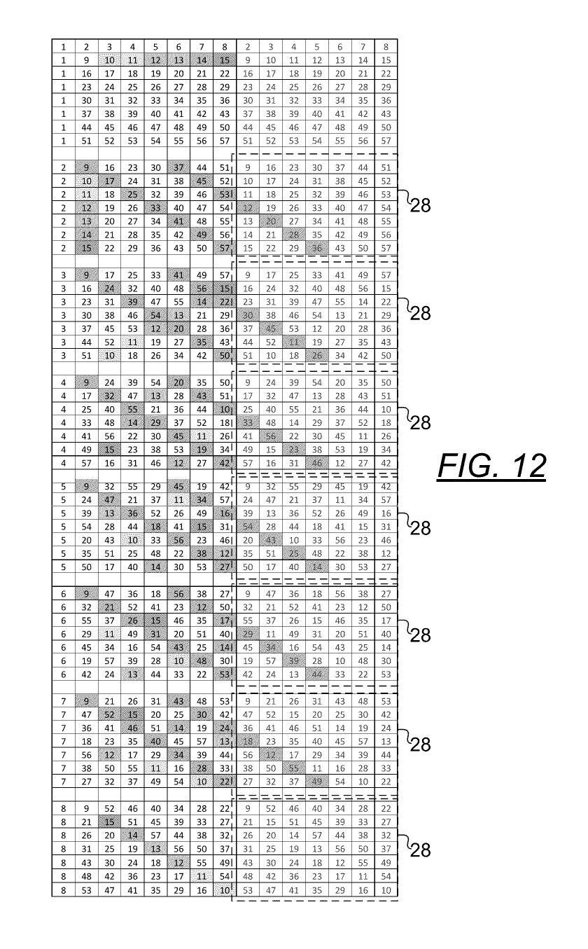

The following is a list of steps for filling out the matrices:
(i) The first step of the method includes providing a table having a plurality of matrices, wherein each matrix is composed of a plurality of rows and a plurality of columns as shown in FIG. 7. The table comprises a total number of matrices equal to the quantity of elements, i.e., eight in this case. The first matrix of the table is a square matrix having a size of the quantity of elements by the quantity of elements, i.e., 8×8 in this case. The other matrices of the table include a size of the quantity of elements of rows−1 by the quantity of elements, i.e., 8×7 in this case.
(ii) The second step involves populating the leftmost column of each matrix with a member of the list starting from the head element such that the leftmost column of every row of each matrix is populated with a member of the list common within each matrix, leaving behind an empty section 14 to the right of the leftmost column 12 in each matrix.
(iii)This is followed by populating the empty section 14 of the first matrix by filling the first matrix, in the order of members of the list, in a row-by-row, left-to-right and top-to-bottom fashion (as shown in directions 22), starting with a second member (i.e., “2” in this case) of the list until the empty section 14 of the first matrix is completely filled.
(iv)This is then followed by populating the empty section of the second matrix by filling the second matrix, in the order of members of the list, in a column-by-column, left-to-right and top-to-bottom fashion (as shown in directions 24), starting with the member of the list that is used to fill the second row, second column position of the first matrix until the empty section 14 of the second matrix is completely filled. The element in the second row and second column position is also the leftmost element of the second row of first matrix less the leftmost column 18.
(v) This is followed by duplicating the filled empty section 14 of the second matrix adjacent the right side of the second matrix to form a ghost section 28. FIG. 9 depicts the second matrix 10 filled with unique elements.
(vi) Next, the empty section 14 of the third matrix is populated by transposing left-to-right, top-to-bottom diagonal members 26 of the combined filled empty section 14 of the second matrix and the ghost section 28 of the second matrix of FIG. 10 starting from the second column, in a row-by-row, left-to-right and top-to-bottom fashion as shown in FIG. 11. FIG. 12 depicts all matrices including filled ghost sections 28.
(vii) Next, steps (iv)-(vi) are repeated until all empty sections of all matrices have been filled to result in the matrices of FIG. 5. Members of each filled row of all of the matrices constitute combinations of a card. For instance, the combination of elements of Card 2 is “1” “9” “10” “11” “12” “13” “14” “15” while the combination of elements of Card 57 is “8” “53” “47” “41” “35” “29” “16” “10.” For a 6-element deck, step (vi) is used for all matrices, except for the last matrix where the empty section of the last matrix is populated by transposing left-to-right, top-to-bottom diagonal members of the combined filled empty section of the previous matrix and the ghost section of the previous matrix starting from the third (instead of second as in step (vi)) column, in a row-by-row, left-to-right and top-to-bottom fashion.

The presently disclosed method is applicable to game card sets having at least four unique elements per card. The present method for yielding combinations of elements for game cards is preferably executed on a computer such that elements of a game may be changed or substituted without undue efforts in tracking such changes/substitutions.

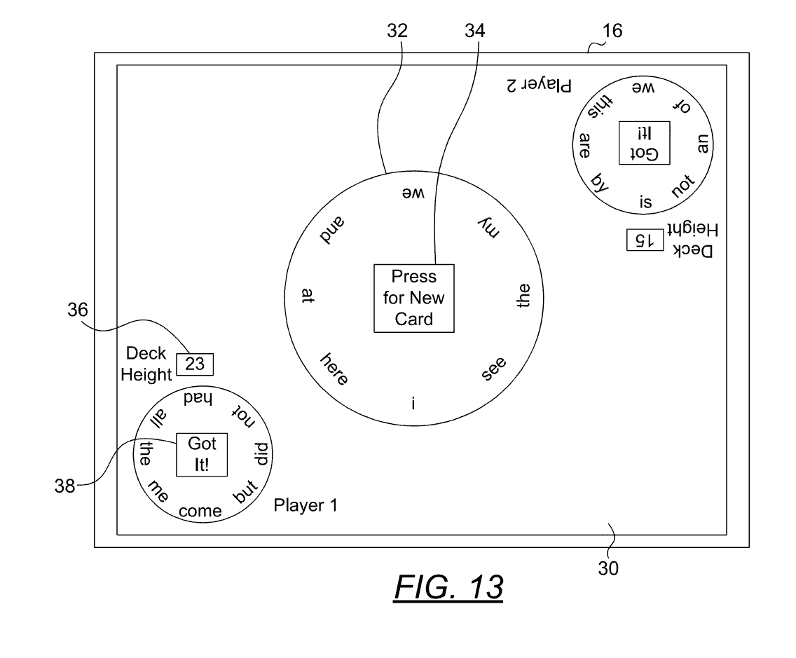

FIG. 13 depicts one embodiment of the present invention adapted for use on a computer. In one embodiment, the computer is a tablet, gaming device, smart phone, desktop, laptop or an electronic touch pad 16 such as IPad®, Samsung Galaxy®, IPhone®, etc. In another embodiment, the computer includes any computing devices capable of running a computer program product performing the functions of the present card game, such as the ability to serve a new card, the ability to receive acknowledgement that a match was found and the ability to tally a score of such match, etc. FIG. 13 shows a game played between two players, i.e., Player 1 and Player 2. The deck 32 of cards is centrally disposed within a touchscreen 30. A soft button 34 is provided to enable one to choose a new card. Upon pressing or touching the button 34, a new card is served. A second button 38 is provided to a player to acknowledge the common element between a player's card and the top card of the deck 32 has been identified. The press of this button 38 adds a point to the player's score. A score counter is provided to display the score 36 garnered by a player.

We claim:

1. A method of playing a card game comprising:
(a) Providing a plurality of cards placed in a deck, wherein each of said plurality of cards comprises:
at least two unique elements wherein said at least two unique elements are disposed adjacent a periphery of each of said plurality of cards;
one element common with any one of the other cards of said plurality of cards; and
a circular shape;
(b) randomly assigning a card of said plurality of cards to each of at least two players;
(c) selecting a seed card from said deck by each of said at least two players;
(d) placing one of said plurality of cards between said at least two players;
(e) identifying and calling the common element between said one of said plurality of cards and said seed card;
(f) collecting said one of said plurality of cards by a player of said at least two players who identified and called the common element, wherein said card is now treated as the seed card; and
(g) Repeating steps (d)-(f) until said deck is depleted, wherein the player possessing the maximum number of cards is determined to be the winner of said card game.

2. The method of claim 1, wherein each of said at least two unique elements is selected from the group consisting of words, numbers, images, symbols, mathematically equivalent statements, mathematically equivalent representations, words of different languages, patterns, and combinations thereof.

3. The method of claim 1, wherein said method is carried out on a computer device selected from the group consisting of electronic touch pad and computer.

4. A method of providing a plurality of cards, wherein each of said plurality of cards comprises a quantity of elements and has one element in common with any one of the other cards of said plurality of cards, and further comprises a list of unique elements having a size and a head element corresponding to a first member of said list, said method comprising:
(a) providing a table having a plurality of matrices, wherein each matrix is composed of a plurality of rows and a plurality of columns, said table comprises a total number of matrices equal to said quantity of elements,
a first matrix of said table is a square matrix having a size of said quantity of elements multiplied by said quantity of elements, and
other matrices of said table include a size of (said quantity of elements of rows−1) multiplied by said quantity of elements;
(b) populating a leftmost column of each matrix with a member of said list starting from said head element such that the leftmost column of each matrix is populated with a member of said list common within each matrix, leaving behind an empty section in each matrix;
(c) populating the empty section of said first matrix by filling said first matrix, in the order of members of said list, in a row-by-row, left-to-right and top-to-bottom fashion, starting with a second member of said list until the empty section of said first matrix is completely filled;
(d) populating the empty section of a second matrix by filling said second matrix, in the order of members of said list, in a column-by-column, left-to-right and top-to-bottom fashion, starting with the member of said list that is used to fill the second row, second column position of said first matrix until the empty section of said second matrix is completely filled;
(e) assigning previously filled matrix as a current matrix;
(f) duplicating the filled empty section of said current matrix adjacent the right side of said current matrix to form a ghost section; and
(g) populating the empty section of a next matrix by transposing left-to-right, top-to-bottom diagonal members of said combined filled empty section of said current matrix and said ghost section of said current matrix starting from the second column of said combined filled empty section of said current matrix, in a row-by-row, left-to-right and top-to-bottom fashion,
wherein steps (e)-(g) are repeated until all empty sections of all matrices have been filled and members of each filled row of all of said matrices constitute combinations of a card.

5. The method of claim 4, wherein said quantity of elements is four.

6. The method of claim 4, wherein said quantity of elements is eight.

7. The method of claim 4, wherein step (g) is replaced with a last step when a next matrix is the last matrix of said matrices, said last step comprises:
populating the empty section of a next matrix by transposing left-to-right, top-to-bottom diagonal members of said combined filled empty section of said current matrix and said ghost section of said current matrix starting from the third column of said combined filled empty section of said current matrix, in a row-by-row, left-to-right and top-to-bottom fashion.

8. The method of claim 7, wherein said quantity of elements is six.

9. The method of claim 4, wherein said method is carried out on a computer.

10. A card game having a plurality of cards, said plurality of cards comprising at least two unique elements and each of said plurality of cards comprises one element common with any one of the other cards of said plurality of cards, wherein each of said plurality of cards comprises a circular shape and said at least two unique elements are disposed adjacent an outer periphery of each of said plurality of cards and said card game is played according to said method of claim 1.

11. The card game of claim 10, wherein each of said at least two unique elements is selected from the group consisting of words, numbers, images, symbols, mathematically equivalent statements, mathematically equivalent representations, words of different languages, patterns and combinations thereof.

12. The card game of claim 10, wherein said card game is a computer program product conducted on a computer device.

13. The card game of claim 12, wherein said computer device is selected from the group consisting of electronic touch pad and computer.

14. The card game of claim 10, wherein said at least two unique elements are words aligned outwardly about the center of each of said plurality of cards.

15. The card game of claim 10, wherein said at least two unique elements are words aligned inwardly about the center of each of said plurality of cards.

16. The card game of claim 10, wherein the number of said plurality of cards is fifty seven.

17. The card game of claim 10, wherein the number of said plurality of cards is thirteen.

18. The card game of claim 10, wherein the number of said plurality of cards is thirty one.
